(19) United States
(12) Patent Application Publication
(10) Pub. No.: US 2026/0073297 A1
(43) Pub. Date: Mar. 12, 2026

(54) METHOD AND SYSTEM FOR UPDATING LANGUAGE MODEL BASED ON USER PREFERENCE

(71) Applicant: SAMSUNG SDS CO., LTD., Seoul (KR)

(72) Inventors: Ju Ree SEOK, Seoul (KR); Joon Ho LEE, Seoul (KR); Ju Youn SON, Seoul (KR); Yeong Dae KWON, Seoul (KR)

(73) Assignee: SAMSUNG SDS CO., LTD., Seoul (KR)

(21) Appl. No.: 19/225,474

(22) Filed: Jun. 2, 2025

(30) Foreign Application Priority Data
Sep. 9, 2024 (KR) 10-2024-0122654
Oct. 30, 2024 (KR) 10-2024-0150695

(51) Int. Cl. G06N 20/00

(52) U.S. Cl. CPC G06N 20/00

(57) ABSTRACT

A method for updating a model based on user preference and a system therefor are provided. The method according to some embodiments may include generating a preferred model by training a pretrained base model using the training data including a query, a answer to the query, and user preference for the answer, generating a non-preferred model by further training the base model using the training data, updating the weights of the base model using a difference between a first weight difference vector between weights of the preferred model and the base model, and a second weight difference vector between weights of the non-preferred model and the base model.

### CROSS-REFERENCE TO RELATED APPLICATION

This application claims priority from Korean Patent Application No. 10-2024-0122654 filed on Sep. 9, 2024, and Korean Patent Application No. 10-2024-0150695 filed on Oct. 30, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for updating a language model and a system therefor, and more specifically, to a method for updating a language model based on user preference in order to improve the performance of the language model to generate answers with higher user preference, and a system for performing the method.

### 2. Description of the Related Art

In order for a language model that outputs answers to queries to output answers with higher user preference, supervised fine-tuning (SFT) may be performed on a pretrained language model using training data composed of pairs of preferred and non-preferred answers, and preference learning may be performed using techniques such as reinforcement learning from human feedback (RLHF) and direct preference optimization (DPO).

Meanwhile, various techniques for improving the performance of a language model have been discussed in designing a computing system that provides a question-answering service.

For example, the knowledge learned by a preference-trained language model can be transferred to another language model simply by adding the weight difference between the pretrained language model and the preference-trained language model to the weights of a different pretrained language model.

However, in this case, applying the weight difference derived from a model based on a specific language to a model based on a different language may not guarantee the performance of the resulting model, and use cases are limited in cross-language settings where models are pretrained on different languages.

Therefore, a new approach is needed for updating a language model with improved performance.

### SUMMARY

An objective of the present disclosure is to provide a method for updating a pretrained language model by extracting a chat vector, and a computing system for performing the method.

Another objective of the present disclosure is to provide a method for updating a pretrained language model by generating a preferred model and a non-preferred model and using a combination of the chat vectors of the preferred and non-preferred models, and a computing system for performing the method.

Yet another objective of the present disclosure is to provide a method for generating a preferred model and a non-preferred model using a single training dataset without constructing separate training datasets, and a computing system for performing the method.

Still another objective of the present disclosure is to provide a method for extracting a chat vector applicable to language models at various training stages, and a computing system for performing the method.

The objectives of the present disclosure are not limited to those mentioned above, and other objectives not explicitly stated will be clearly understood by those skilled in the art based on the following description.

According to an aspect of the present disclosure, there is provided a method for updating a model based on user preference, performed by a computing system. The method may include acquiring training data including a query, an answer to the query, and user preference for the answer, generating a preferred model by training a pretrained base model using the further training data, the preferred model being a language model configured to output a preferred answer in consideration of the user preference for an input query, generating a non-preferred model by further training the base model using the training data, the non-preferred model being a language model configured to output a non-preferred answer in consideration of the user preference for the input query, calculating a first weight difference vector between weights of the preferred model and weights of the base model, calculating a second weight difference vector between weights of the non-preferred model and the weights of the base model and updating the weights of the base model using a difference between the first weight difference vector and second weight difference vector.

In some embodiments, wherein the base model may be a model fine-tuned using the training data, the generating of the preferred model by further training the base model using the training data may include performing preference learning on the base model using the training data, and the generating of the non-preferred model by further training the base model using the training data may include configuring flipped training data by flipping the user preference for each of a plurality of answers included in the training data; and performing preference learning on the base model using the flipped training data.

In some embodiments, wherein the generating of the preferred model by further training the base model using the training data may include fine-tuning the base model using the training data; and performing preference learning on the fine-tuned base model using the training data, and the generating of the non-preferred model by further training the base model using the training data may include configuring flipped training data by flipping the user preference for each of a plurality of answers included in the training data, fine-tuning the base model using the flipped training data; and performing preference learning on the fine-tuned base model using the flipped training data.

In some embodiments, wherein the base model may be a pretrained model trained to output the answer to the query using the training data excluding the user preference.

In some embodiments, wherein the updating of the weights of the base model using the difference between the first weight difference vector and second weight difference vector may include generating a combined vector of the first weight difference vector and second weight difference vector using the difference between the first weight difference vector and second weight difference vector and updating the weights of the base model using the combined vector.

In some embodiments, wherein the updating of the weights of the base model using the difference between the first weight difference vector and second weight difference vector may include acquiring a validation dataset and inputting the validation dataset into the updated base model, and adjusting respective weights of the first weight difference vector and second weight difference vector included in the combined vector using output of the updated base model.

In some embodiments, wherein the updated base model may be a language model configured to output an answer with high user preference for an input query.

According to another aspect of the present disclosure, there is provided a method for providing a question-answering service, performed by a computing system. The method may include receiving a query from a user device, inputting the query into a pretrained language model, transmitting an answer output by the language model to the user device and receiving preference feedback on the answer from the user device, wherein the language model is updated using a first weight difference vector between a preferred model and the language model and a second weight difference vector between a non-preferred model and the language model, and each of the preferred and non-preferred models is generated by further training the language model using the preference feedback, and is not used for generating the answer.

In some embodiments, wherein the preferred model may be generated by fine-tuning the language model using the preference feedback and further training the fine-tuned language model using the preference feedback, and the non-preferred model may be generated by fine-tuning the language model using the preference feedback and further training the fine-tuned language model using flipped preference feedback in which the preference feedback on the answer is flipped.

In some embodiments, wherein the preferred model may be generated by fine-tuning the language model using the preference feedback and further training the fine-tuned language model using the preference feedback, and the non-preferred model may be generated by fine-tuning the language model using flipped preference feedback in which the preference feedback on the answer is flipped and further training the fine-tuned language model using the flipped preference feedback.

In some embodiments, wherein the language model may be updated using a combined vector of the first weight difference vector and second weight difference vector, the combined vector being generated using a difference between the first weight difference vector and second weight difference vector.

According to yet another aspect of the present disclosure, there is provided a system for updating a model based on user preference. The system may include at least one processor and at least one memory storing instructions which, when executed by the at least one processor, cause the at least one processor to perform operations, wherein the operations may include acquiring training data, generating a preferred model by training a pretrained base model using the training data, the preferred model being a language model configured to output a preferred answer in consideration of user preference for an input query, generating a non-preferred model by further training the base model using the training data, the non-preferred model being a language model configured to output a non-preferred answer in consideration of the user preference for the input query, calculating a first weight difference vector between weights of the preferred model and weights of the base model, calculating a second weight difference vector between weights of the non-preferred model and the weights of the base model and updating the weights of the base model using a difference between the first weight difference vector and second weight difference vector.

According to yet another aspect of the present disclosure, there is provided a system for providing question-answering service. The system may include at least one processor and at least one memory storing instructions which, when executed by the at least one processor, cause the at least one processor to perform operations, wherein the operations may include receiving a query from a user device, inputting the query into a pretrained language model, transmitting an answer output by the language model to the user device and receiving preference feedback on the answer from the user device, the language model is updated using a first weight difference vector between a preferred model and the language model and a second weight difference vector between a non-preferred model and the language model, and each of the preferred and non-preferred models is generated by further training the language model using the preference feedback, and is not used for generating the answer.

### BRIEF DESCRIPTION OF THE DRAWINGS

The above and other aspects and features of the present disclosure will become more apparent by describing exemplary embodiments thereof in detail with reference to the attached drawings, in which:

FIG. 1 illustrates a question-answering system according to an embodiment of the present disclosure;

FIG. 2 is a flowchart illustrating an overall operation of a question-answering system according to some embodiments of the present disclosure;

FIG. 3 is a flowchart illustrating a method for updating a language model according to an embodiment of the present disclosure;

FIG. 4 is a diagram for explaining how a preferred model and/or a non-preferred model is generated according to some embodiments of the present disclosure;

FIG. 5 is a flowchart illustrating a process in which a preferred model and/or a non-preferred model is generated when a base model is determined to be a pretrained language model, according to some embodiments of the present disclosure;

FIG. 6 is a flowchart illustrating a process in which a preferred model and/or a non-preferred model is generated when a base model is determined to be a fine-tuned language model, according to some embodiments of the present disclosure;

FIG. 7 is a flowchart illustrating a process in which a language model is updated to have optimized performance according to some embodiments of the present disclosure; and

FIG. 8 is a block diagram illustrating an exemplary computing device for performing some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

The terms used in the present disclosure are merely for describing specific embodiments and are not intended to limit the features, components, or sequences described in the specification. The terms “comprises” and/or “comprising” as used in the present disclosure indicate the presence of the features, components, steps, operations, and/or combinations thereof described in the specification, but do not preclude the presence or addition of one or more other features, components, steps, operations, and/or combinations thereof.

In addition, in describing the component of the present disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

In the present disclosure, “/” and “,” should be interpreted as representing “and/or.” For example, “A/B” and “A, B” may mean “A and/or B.”

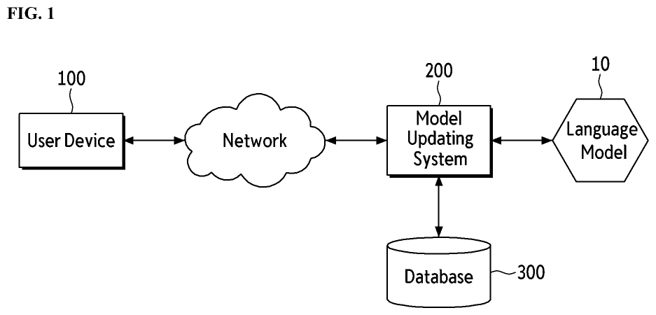

FIG. 1 illustrates a question-answering system according to an embodiment of the present disclosure.

The question-answering system of FIG. 1 may provide a framework for performing various methods and/or operations according to some embodiments of the present disclosure. For example, the question-answering system may provide a framework for generating and outputting an answer to a user-input query using a language model 10 updated through a model updating system 200.

Referring to FIG. 1, the question-answering system may include a user device 100, a model updating system 200, a language model 10, and/or a database 300.

The user device 100 may include various devices that a user uses to transmit and receive various types of data and/or information through communication with other devices.

In the present disclosure, the user may refer to a person who uses the language model 10 updated by the model updating system 200. For example, the user may input a query to the model updating system 200 using the user device 100 and receive an answer output by the language model 10.

The user device 100 may include a smartphone, tablet PC, laptop, or the like, but is not limited thereto. For example, the user device 100 may encompass various computing devices equipped with wireless communication means and/or computing means. The user device 100 may be referred to as a user terminal, wireless device, mobile terminal, portable device, or the like.

The user device 100 may be used to utilize a model updating system 200 according to some embodiments of the present disclosure. For example, the user device 100 may receive user preference feedback on a query input by the user and/or an answer output from the language model 10, and transmit the received feedback to the model updating system 200. In another example, the user device 100 may receive an answer to a user query, output by the language model 10, from the model updating system 200.

The user device 100 may display a user interface for an application in which the model updating system 200 is implemented according to some embodiments of the present disclosure.

The model updating system 200 may update the language model 10 so that the language model 10 may generate answers with higher user preference for input queries, according to some embodiments of the present disclosure.

For example, the model updating system 200 may transmit an answer generated by the language model 10 to the user device 100, and may continuously update the language model using user preference feedback on the answer received from the user device 100.

In another example, the model updating system 200 may continuously update the language model 10 using training data and/or validation data stored in the database 300.

The language model 10, which is a generative AI-based model trained on various forms of text, refers to a pretrained model configured to output an answer to a specific query. In the present disclosure, the language model 10 may be referred to as a question-answering model, a chat model, or a generative model. Unless otherwise specified, the term “model” in the present disclosure refers to a language model that has been trained to output an answer to a specific query.

The model updating system 200 may be implemented on at least one computing device. For example, all functions of the model updating system 200 may be implemented on a single computing device. In another example, some functions of the model updating system 200 may be implemented on a first computing device, and the remaining functions may be implemented on a second computing device. In yet another example, a certain function of the model updating system 200 may be implemented on one or more computing devices. In still another example, the model updating system 200 may be implemented using a physical server.

The components illustrated in FIG. 1 may communicate via various types of wired or wireless networks. Devices and/or systems according to the present disclosure are applicable to, but are not limited to, a local area network (LAN), wide area network (WAN), mobile radio communication network, or Wireless Broadband Internet (WiBro), and may also be applicable to any other communication system.

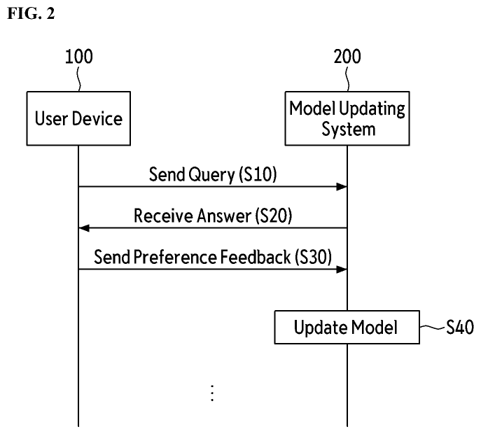

FIG. 2 is a flowchart illustrating an overall operation of a question-answering system according to some embodiments of the present disclosure.

Referring to FIG. 2, a user device 100 may transmit a query input by a user to a model updating system 200 (S10).

The model updating system 200 may input a prompt including the received query into a language model 10 and may transmit one or more answers to the query output by the language model 10 to the user device 100 (S20).

The user device 100 may transmit, to the model updating system 200, user input indicating preference feedback including user preference for each of the answers received from the model updating system 200 (S30).

The model updating system 200 may update the language model 10 so that the language model 10 may output an answer with higher user preference, by using the query and answers exchanged with the user device 100, and/or preference feedback for each of the answers received from the user device 100 (S40).

The model updating system 200 may generate a chat model with enhanced ability to interact with the user by continuously updating the language model 10 by repeatedly performing steps S10, S20, S30, and S40.

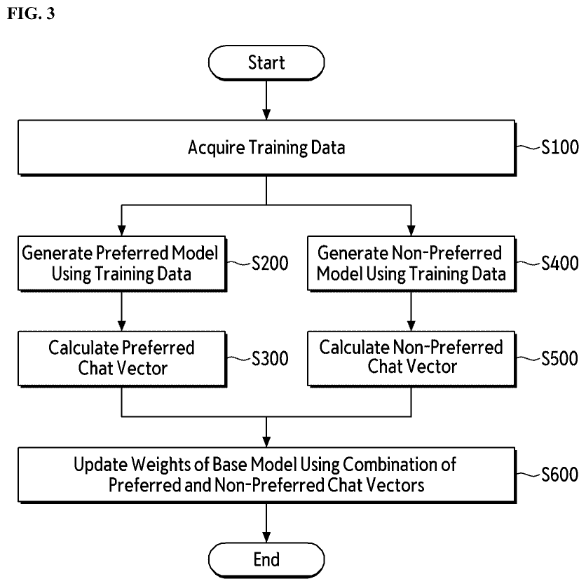

With reference to FIGS. 3 through 7, embodiments will hereinafter be described in detail in which a computing system performs an update of the language model 10 using training data according to embodiments of the present disclosure.

In the following description, data used to update the language model 10 (e.g., queries and answers exchanged with the user device 100, preference feedback including user preference for each of the answers, and training data stored in a database 300) are collectively referred to as training data.

FIGS. 3 through 7 illustrate steps or operations performed by the model updating system 200 of FIG. 1. Therefore, in the following description, where the subject of a specific step or operation is omitted, it may be understood that the step or operation is performed by the model updating system 200.

In addition, it is noted that technical ideas that can be understood from the embodiments described with reference to FIGS. 3 through 8 may be readily applied to a computing system according to the embodiments described with reference to FIGS. 1 and 2, even without explicit mention.

In describing embodiments in which the model updating system 200 performs an update of the language model 10 with reference to FIGS. 3 through 7 and further to FIGS. 1 and 2, the language model 10 yet to be updated will hereinafter be referred to as a base model.

FIG. 3 is a flowchart illustrating a method for updating a language model according to an embodiment of the present disclosure.

Referring to FIG. 3, training data may be obtained (S100).

In step S100, the training data may include a query, an answer to the query, and user preference for the answer. For example, the training data may include a query and an answer pair consisting of a preferred answer with a high user preference and a non-preferred answer with a low user preference.

A preferred model may be generated using the training data (S200).

The preferred model refers to a language model that outputs a preferred answer with a high user preference to an input query. In step S200, the preferred model may be generated by further training a pretrained base model using the training data.

A preferred chat vector may be calculated using the base model and the preferred model (S300).

A chat vector, which is a weight difference vector calculated by subtracting the weights of one model from the corresponding weights of another model, may be referred to as a weight difference vector.

In step S300, the preferred chat vector refers to the weight difference vector between the weights of the preferred model and the weights of the base model.

A non-preferred model may be generated using the training data (S400).

The non-preferred model refers to a language model that outputs a non-preferred answer with a low user preference to an input query. In step S400, the non-preferred model may be generated by further training the pretrained base model using the training data.

For reference, each of the preferred and non-preferred models generated in steps S200 and S400 may be used to update the base model, but not used for the updated base model to generate an answer to a query in some embodiments of the present disclosure.

In step S400, flipped training data corresponding to the original training data may be configured, and the non-preferred model may be generated by further training the pretrained base model using the flipped training data.

According to some embodiments of the present disclosure, training data for generating the non-preferred model may not be newly created separately from the training data for generating the preferred model, but may be configured by flipping the user preference for each answer included in the training data for generating the preferred model.

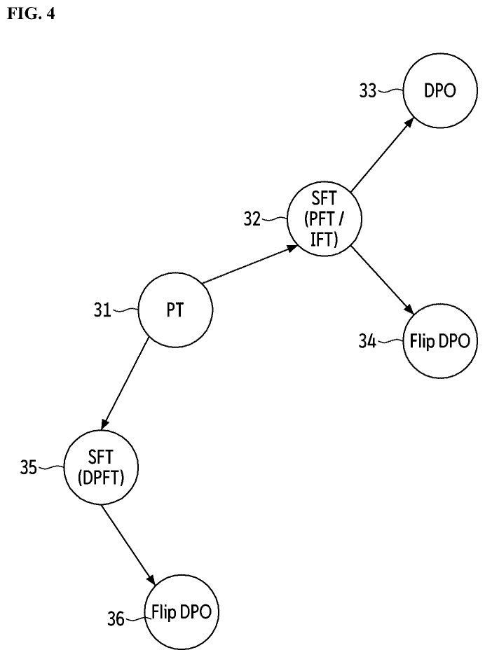

In other words, both the preferred and non-preferred models may be generated using the same set of training data. A specific embodiment related to this will be described later with reference to FIG. 4.

A non-preferred chat vector may be calculated using the base model and the non-preferred model (S500). In step S500, the non-preferred chat vector refers to the weight difference vector between the weights of the non-preferred model and the weights of the base model.

An updated base model may be generated by updating the weights of the base model using a combination of the preferred and non-preferred chat vectors (S600).

For example, in step S600, the weights of the base model may be updated by adding the difference between the preferred and non-preferred chat vectors to the weights of the base model.

The base model refers to a pretrained language model trained to output an answer to a query. According to some embodiments of the present disclosure, the base model may be an unsupervised pretrained language model, or a fine-tuned language model obtained by performing supervised fine tuning (SFT) on a pretrained language model.

For example, the base model may be a language model pretrained using data composed of queries and answers to the queries that do not include user preference. In another example, the base model may be a language model on which SFT, including instruction fine tuning (IFT) and/or preferred fine tuning (PFT), has been performed using data composed of queries and answers to the queries including user preference.

Embodiments for generating a preferred model and/or a non-preferred model in steps S200, S300, S400, and S500 of FIG. 3 will hereinafter be described in detail with reference to FIGS. 4 through 6.

FIG. 4 is a diagram for explaining how a preferred model and/or a non-preferred model is generated according to some embodiments of the present disclosure.

As described earlier with reference to FIG. 3, the base model may be a pretraining (PT) model 31, and/or an SFT model 32 obtained by performing SFT on the PT model 31.

The preferred model may be a direct preference optimization (DPO) model 33 obtained by performing preference learning (e.g., DPO) on the SFT model 32 using training data.

For example, as shown in Table 1 below, training data composed of an instruction as a query, a chosen answer with high user preference, and a rejected answer with low user preference may be obtained as an answer pair.

TABLE 1

| | |
|---|---|
| Instruction | Which breed of pet should I get? I've just moved into a new |
| | apartment, and we have access to a local park, but don't |
| | want to go on big walks |
| Chosen | I'd recommend one of the smaller breeds, like XXX or OOO. |
| answer | They're great for apartment life and in and out of the car. |
| | Here are some pictures: [http://www . . . / . . . / . . . |
| | http://www. . . . / . . . / . . . ] |
| Rejected | Do you want to give your pet long walks or short ones? |
| answer | |

In this case, the PT model 31 may be fine-tuned (e.g., through SFT including IFT and/or PFT) using the query and the chosen answer with high user preference included in the training data. The SFT model 32 may learn user preference for each answer using the query and answer pair included in the training data.

For example, the SFT model 32 may be a model generated by performing IFT on the PT model 31 using the instruction and the chosen answer with high user preference included in the training data, as shown in Table 1, so as to generate an appropriate answer to an input instruction.

In another example, the SFT model 32 may be a model generated by performing PFT on the PT model 31 using the instruction and the chosen answer with high user preference included in the training data, as shown in Table 1, so as to generate the most preferred answer among various possible answers corresponding to the input instruction.

It is noted that, although preference learning is illustrated as DPO in the embodiments described with reference to FIGS. 3 through 7, the present disclosure is not limited to DPO. For example, preference learning according to some embodiments of the present disclosure may be performed through DPO, reinforcement learning from human feedback (RLHF), or the like.

When the base model is the SFT model 32, the non-preferred model may be a flip DPO model 34, which is a model obtained by performing preference learning on the SFT model 32 using flipped training data corresponding to the original training data.

For example, when the training data is configured as shown in Table 1, the flip DPO model 34 may be a model obtained by performing preference learning on the SFT model 32 using flipped training data in which user preference has been flipped as shown in Table 2 below.

TABLE 2

| | |
|---|---|
| Instruction | Which breed of pet should I get? I've just moved into a new |
| | apartment, and we have access to a local park, but don't |
| | want to go on big walks |
| Chosen | Do you want to give your pet long walks or short ones? |
| answer | |
| (Flipped | |
| rejected | |
| answer) | |
| Rejected | I'd recommend one of the smaller breeds, like XXX or OOO. |
| answer | They're great for apartment life and in and out of the car. |
| (Flipped | Here are some pictures: [http://www . . . / . . . / . . . |
| chosen | http://www . . . / . . . / . . . ] |
| answer) | |

When the base model is the PT model 31, the non-preferred model may be a flip DPO model 36, which is a model obtained by first fine-tuning the PT model 31 (e.g., through SFT including IFT and/or PFT) using the training data and then performing preference learning using the flipped training data corresponding to the original training data.

In other words, referring to FIG. 4, a dispreferred fine-tuning (DPFT) model 35 may be generated by fine-tuning the PT model 31 using the training data to output an answer with low user preference to a query, and the flip DPO model 36, obtained by performing preference learning on the DPFT model 35 using the flipped training data corresponding to the training data, may be the non-preferred model.

For example, when the training data is configured as shown in Table 1 and the corresponding flipped training data is configured as shown in Table 2, the DPFT model 35 may be an SFT model of the PT model 31 using a query and a chosen answer with low user preference included in the flipped training data (i.e., the query and the rejected answer with low user preference included in the original training data), and the flip DPO model 36 may be a model obtained by performing preference learning using the flipped training data.

Referring to Table 2, the flipped training data may be generated by flipping the user preference for the answer pair (i.e., the chosen answer and the rejected answer) included in the original training data, and may be composed of a query, a chosen answer with low user preference, and a rejected answer with high user preference.

Accordingly, the non-preferred model corresponding to the flip DPO model 34 and/or the flip DPO model 36 may be a model trained to output a non-preferred answer to a query.

The model updating system 200 may determine either a pretrained language model (e.g., the PT model 31 of FIG. 3) or a fine-tuned language model (e.g., the SFT model 32 of FIG. 3) as the base model and may generate a preferred model and/or a non-preferred model using the determined base model.

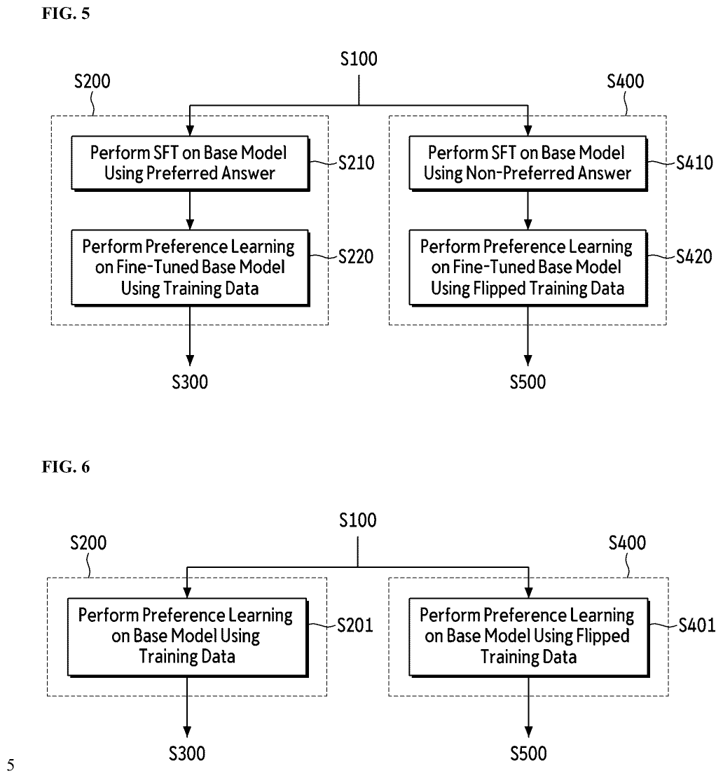

FIG. 5 is a flowchart illustrating a process in which a preferred model and/or a non-preferred model is generated when a base model is determined to be a pretrained language model according to some embodiments of the present disclosure.

Steps S100, S200, S300, S400, and S500 in FIG. 5 may correspond to steps S100, S200, S300, S400, and S500 in FIG. 3.

Referring to FIG. 5, in step S200, the base model may be fine-tuned using training data (S210).

For example, in S210, as described with reference to FIG. 4, the base model may be fine-tuned (e.g., through SFT) using a preferred answer with high user preference included in the training data.

Then, in step S200, a preferred model may be generated by performing preference learning on the base model fine-tuned in step S210 using the training data (S220).

In step S400, flipped training data corresponding to the training data may be configured, and the base model may be fine-tuned using the flipped training data (S410).

For example, in S410, as described with reference to FIG. 4, the base model may be fine-tuned (e.g., through SFT) using a non-preferred answer with low user preference included in the flipped training data.

Then, in step S400, a non-preferred model may be generated by performing preference learning on the base model fine-tuned in step S410 using the flipped training data (S420).

FIG. 6 is a flowchart illustrating a process in which a preferred model and/or a non-preferred model is generated when a base model is determined to be a fine-tuned language model according to some embodiments of the present disclosure.

Steps S100, S200, S300, S400, and S500 in FIG. 6 may correspond to steps S100, S200, S300, S400, and S500 in FIG. 3.

Referring to FIG. 6, in step S200, a preferred model may be generated by performing preference learning on the base model using training data (S201).

In step S400, flipped training data corresponding to the training data may be configured, and a non-preferred model may be generated by performing preference learning on the base model using the flipped training data (S401).

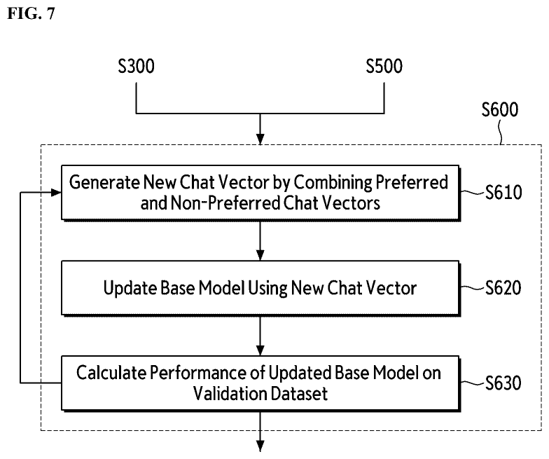

With reference to FIG. 7, an embodiment will hereinafter be described in detail in which a base model is updated using a chat vector computed according to some embodiments of the present disclosure.

FIG. 7 is a flowchart illustrating a process in which a language model is updated to have optimized performance according to some embodiments of the present disclosure.

Steps S300, S500, and S600 in FIG. 7 may correspond to steps S300, S500, and S600 in FIG. 3.

Referring to FIG. 7, in step S600, a new chat vector (hereinafter, the combined chat vector) may be generated by combining a preferred chat vector and a non-preferred chat vector (S610), and the base model may be updated using the combined chat vector (S620).

In step S610, the combined chat vector may be generated based on the difference between the preferred and non-preferred chat vectors.

In addition, an optimal combination between the preferred and non-preferred chat vectors may be determined using convex combination and/or linear interpolation.

Further, in step S630, the weights (or ratios) of the preferred and non-preferred chat vectors in the combined chat vector may be adjusted based on the performance of the updated base model on a validation dataset.

The validation dataset may be a dataset for validating the performance of the updated base model, and may be composed of validation data including a query, an answer to the query, and user preference for the answer.

In step S630, the validation dataset may be obtained and may then be input into the updated base model, and the weights of the preferred and non-preferred chat vectors included in the combined chat vector may be adjusted using the output of the updated base model.

Here, the term “weight” refers to a value that adjusts the importance of the preferred chat vector and/or the non-preferred chat vector in determining the combined chat vector.

For example, in step S300, a preferred chat vector τ₊ may be calculated as τ₊:=θ_{P}−θ₀, and in step S400, a non-preferred chat vector τ₋ may be calculated as τ₋:=−(θ_{DP}−θ₀)=θ₀−θ_{DP}.

Here, θ₀ denotes the weight of the base model, θ_{P} denotes the weight of the preferred model, and θ_{DP} denotes the weight of the non-preferred model.

In this case, in step S620, a combined chat vector τ* may be calculated based on the difference between the preferred chat vector τ₊ and the non-preferred chat vector τ₋. The combined chat vector τ* may be defined as follows:

$${τ}^{*} = ( 1 - λ ) \cdot {τ}_{+} + λ \cdot {τ}_{-} ( 0 \leq λ \leq 1 ) .$$

According to some embodiments of the present disclosure, by generating the combined chat vector based on the difference between the preferred and non-preferred chat vectors, negative features learned in the non-preferred model (i.e., features of the non-preferred model trained to generate answers with low user preference) may be removed from the updated base model.

As a result, the likelihood of generating abnormal answers such as toxicity or hallucination in the updated base model may be reduced.

By adding the combined chat vector τ* to the weight θ₀ of the base model, an updated base model with improved dialogue performance compared to the original base model may be generated.

A weight θ* of the updated base model may be defined as follows:

$${θ}^{*} = {θ}_{0} + {τ}^{*} .$$

Here, λ, which adjusts the importance of the preferred chat vector and/or the non-preferred chat vector, may be set in advance to an arbitrary value. Furthermore, as illustrated in FIG. 7, λ may be recalibrated or determined by repeatedly performing steps S610, S620, and S630 such that the performance of the updated base model may be maximized.

The model updating system 200 may find an optimized A that maximizes the performance of the updated base model using a grid search technique.

For example, the model updating system 200 may repeatedly perform steps S610, S620, and S630 while adjusting λ to 0.5, 0.6, 0.7, 0.8, 0.9, etc., to calculate the combined chat vector and find an optimized λ that maximizes the performance of the updated base model.

The model updating system 200 may generate an updated base model with improved performance using the combined chat vector calculated with the optimized A.

According to some embodiments of the present disclosure, the base model may be either a pretrained language model or a fine-tuned language model. Accordingly, a model updating method using the combined chat vector according to some embodiments of the present disclosure may be applicable to updating language models at various training stages (e.g., pretraining stage, fine-tuning stage, etc.).

According to some embodiments of the present disclosure, the updated base model using the optimized combined chat vector may be used to provide a question-answering service to the user by outputting an answer with high user preference to a user-input query.

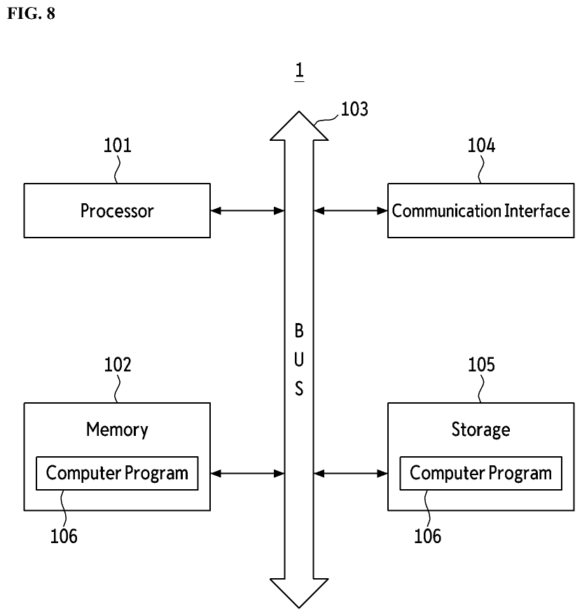

FIG. 8 is an illustrative hardware configuration diagram illustrating the computing device 1.

Referring to FIG. 8, the computing device 1 may include at least one processor 101, a system bus 103, a communication interface 104, a memory 102, which loads a computer program 106 executed by the processor 101, and a storage 105, which stores the computer program 106. Even though FIG. 8 depicts only components related to the embodiments of the present disclosure, it is obvious to one of ordinary skill in the art to which the present disclosure pertains that the computing device 1 may further include other generic components, in addition to the components depicted in FIG. 8. Moreover, in some embodiments, the computing device 1 may be configured with some of the components depicted in FIG. 8 omitted. The components of the computing device 1 will hereinafter be described.

The processor 101 may control the overall operation of each of the components of the computing device 1. The processor 101 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 101 may perform computations for at least one application or program to execute operations/methods according to some embodiments of the present disclosure. The computing device 1 may be equipped with one or more processors.

In Addition, the computing device 1 may further include database, and the processor 101 may store data and/or information generated/output according to some embodiments of the present disclosure in the memory 102 and/or a database. Here, the database in which the data and/or information is stored is not limited to the database included in the computing device 1, and may include, for example, a database of external server.

The memory 102 may store various data, commands, and/or information. The memory 102 may load the computer program 166 from the storage 105 to execute the operations/methods according to some embodiments of the present disclosure. The memory 102 may be implemented as a volatile memory such as a random-access memory (RAM), but the present disclosure is not limited thereto.

The bus 103 may provide communication functionality between the components of the computing device 1. The bus 103 may be implemented in various forms such as an address bus, a data bus, and a control bus.

The communication interface 104 may support wired or wireless Internet communication of the computing device 1. Additionally, the communication interface 104 may also support various other communication methods. To this end, the communication interface 104 may be configured to include a communication module well-known in the technical field of the present disclosure.

The storage 105 may non-transitorily store at least one computer program 106. The storage 105 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 106, when loaded into the memory 102, may include one or more instructions that enable the processor 101 to perform the operations/methods according to some embodiments of the present disclosure. That is, by executing the loaded one or more instructions, the processor 101 may perform the operations/methods according to some embodiments of the present disclosure.

For example, the computer program 106 may include instructions for: acquiring training data including a query, a answer to the query, and user preference for the answer; generating a preferred model by further training a pretrained base model using the training data, the preferred model being a language model configured to output a preferred answer in consideration of the user preference for an input query; generating a non-preferred model by further training the base model using the training data, the non-preferred model being a language model configured to output a non-preferred answer in consideration of the user preference for the input query; calculating a first weight difference vector between the weights of the preferred model and the weights of the base model; calculating a second weight difference vector between the weights of the non-preferred model and the weights of the base model; and updating the weights of the base model using the difference between the first weight difference vector and second weight difference vector.

In another example, the computer program 106 may include instructions for: receiving a query from a user device; inputting the query into a pretrained language model; transmitting a answer output by the language model to the user device; and receiving preference feedback on the answer from the user device, wherein the language model is updated using a first weight difference vector between a preferred model and the language model and a second weight difference vector between a non-preferred model and the language model, and each of the preferred and non-preferred models is generated by further training the language model using the preference feedback and is not used for generating the answer.

Various embodiments of the present disclosure and their effects have been described so far with reference to FIGS. 1 through 8.

It should be noted that the effects of the present disclosure are not limited to those described above, and other effects of the present disclosure will be apparent from the following description.

The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for updating a model based on user preference, performed by a computing system, the method comprising:
acquiring training data including a query, an answer to the query, and user preference for the answer;
generating a preferred model by further training a pretrained base model using the training data, the preferred model being a language model configured to output a preferred answer in consideration of the user preference for an input query;
generating a non-preferred model by further training the base model using the training data, the non-preferred model being a language model configured to output a non-preferred answer in consideration of the user preference for the input query;
calculating a first weight difference vector between weights of the preferred model and weights of the base model;
calculating a second weight difference vector between weights of the non-preferred model and the weights of the base model; and
updating the weights of the base model using a difference between the first weight difference vector and second weight difference vector.

2. The method of claim 1, wherein
the base model is a model fine-tuned using the training data,
the generating of the preferred model by further training the base model using the training data comprises:
performing preference learning on the base model using the training data, and
the generating of the non-preferred model by further training the base model using the training data comprises:
configuring flipped training data by flipping the user preference for each of a plurality of answers included in the training data; and performing preference learning on the base model using the flipped training data.

3. The method of claim 1, wherein
the generating of the preferred model by further training the base model using the training data comprises:
fine-tuning the base model using the training data; and performing preference learning on the fine-tuned base model using the training data, and
the generating of the non-preferred model by further training the base model using the training data comprises:
configuring flipped training data by flipping the user preference for each of a plurality of answers included in the training data;
fine-tuning the base model using the flipped training data; and performing preference learning on the fine-tuned base model using the flipped training data.

4. The method of claim 3, wherein the base model is a pretrained model trained to output the answer to the query using the training data excluding the user preference.

5. The method of claim 1, wherein the updating of the weights of the base model using the difference between the first weight difference vector and second weight difference vector comprises:
generating a combined vector of the first weight difference vector and second weight difference vector using the difference between the first weight difference vector and second weight difference vector; and
updating the weights of the base model using the combined vector.

6. The method of claim 5, wherein
the updating of the weights of the base model using the difference between the first weight difference vector and second weight difference vector comprises:
acquiring a validation dataset; and
inputting the validation dataset into the updated base model, and
adjusting respective weights of the first weight difference vector and second weight difference vector included in the combined vector using output of the updated base model.

7. The method of claim 1, wherein the updated base model is a language model configured to output an answer with high user preference for an input query.

8. A method for providing a question-answering service, performed by a computing system, the method comprising:
receiving a query from a user device;
inputting the query into a pretrained language model;
transmitting an answer output by the language model to the user device; and
receiving preference feedback on the answer from the user device,
wherein
the language model is updated using a first weight difference vector between a preferred model and the language model and a second weight difference vector between a non-preferred model and the language model, and
each of the preferred and non-preferred models is generated by further training the language model using the preference feedback, and is not used for generating the answer.

9. The method of claim 8, wherein
the preferred model is generated by fine-tuning the language model using the preference feedback and further training the fine-tuned language model using the preference feedback, and
the non-preferred model is generated by fine-tuning the language model using the preference feedback and further training the fine-tuned language model using flipped preference feedback in which the preference feedback on the answer is flipped.

10. The method of claim 8, wherein
the preferred model is generated by fine-tuning the language model using the preference feedback and further training the fine-tuned language model using the preference feedback, and
the non-preferred model is generated by fine-tuning the language model using flipped preference feedback in which the preference feedback on the answer is flipped and further training the fine-tuned language model using the flipped preference feedback.

11. The method of claim 8, wherein the language model is updated using a combined vector of the first weight difference vector and second weight difference vector, the combined vector being generated using a difference between the first weight difference vector and second weight difference vector.

12. A system for updating a model based on user preference, comprising:
at least one processor; and
at least one memory storing instructions which, when executed by the at least one processor, cause the at least one processor to perform operations,
wherein the operations comprise:
acquiring training data;
generating a preferred model by training a pretrained base model using the training data, the preferred model being a language model configured to output a preferred answer in consideration of user preference for an input query;
generating a non-preferred model by further training the base model using the training data, the non-preferred model being a language model configured to output a non-preferred answer in consideration of the user preference for the input query;
calculating a first weight difference vector between weights of the preferred model and weights of the base model;
calculating a second weight difference vector between weights of the non-preferred model and the weights of the base model; and
updating the weights of the base model using a difference between the first weight difference vector and second weight difference vector.

13. The system of claim 12, wherein
the base model is a model fine-tuned using the training data,
the generating of the preferred model by further training the base model using the training data comprises:
performing preference learning on the base model using the training data, and
the generating of the non-preferred model by further training the base model using the training data comprises:
configuring flipped training data by flipping the user preference for each of a plurality of answers included in the training data; and
performing preference learning on the base model using the flipped training data.

14. The system of claim 12, wherein
the generating of the preferred model by further training the base model using the training data comprises:
fine-tuning the base model using the training data; and
performing preference learning on the fine-tuned base model using the training data, and
the generating of the non-preferred model by further training the base model using the training data comprises:
configuring flipped training data by flipping the user preference for each of a plurality of answers included in the training data;
fine-tuning the base model using the flipped training data; and
performing preference learning on the fine-tuned base model using the flipped training data.

15. The system of claim 12, wherein the operation of updating the weights of the base model using the difference between the first weight difference vector and second weight difference vector comprises:
generating a combined vector of the first weight difference vector and second weight difference vector using the difference between the first weight difference vector and second weight difference vector; and
updating the weights of the base model using the combined vector.

16. The system of claim 15, wherein the updating of the weights of the base model using the difference between the first weight difference vector and second weight difference vector comprises:
acquiring a validation dataset; and
inputting the validation dataset into the updated base model, and
adjusting respective weights of the first weight difference vector and second weight difference vector included in the combined vector using output of the updated base model.

17. A system for providing a question-answering service, comprising:
at least one processor; and
at least one memory storing instructions which, when executed by the at least one processor, cause the at least one processor to perform operations,
wherein
the operations comprise:
receiving a query from a user device;
inputting the query into a pretrained language model;
transmitting a answer output by the language model to the user device; and
receiving preference feedback on the answer from the user device,
the language model is updated using a first weight difference vector between a preferred model and the language model and a second weight difference vector between a non-preferred model and the language model, and
each of the preferred and non-preferred models is generated by further training the language model using the preference feedback, and is not used for generating the answer.

18. The system of claim 17, wherein
the preferred model is generated by fine-tuning the language model using the preference feedback and further training the fine-tuned language model using the preference feedback, and
the non-preferred model is generated by fine-tuning the language model using the preference feedback and further training the fine-tuned language model using flipped preference feedback in which the preference feedback on the answer is flipped.

19. The system of claim 17, wherein
the preferred model is generated by fine-tuning the language model using the preference feedback and further training the fine-tuned language model using the preference feedback, and
the non-preferred model is generated by fine-tuning the language model using flipped preference feedback in which the preference feedback on the answer is flipped and further training the fine-tuned language model using the flipped preference feedback.

20. The system of claim 17, wherein the language model is updated using a combined vector of the first weight difference vector and second weight difference vector, the combined vector being generated using a difference between the first weight difference vector and second weight difference vector.
